(19) United States
(12) Patent Application Publication
(10) Pub. No.: US 2018/0037046 A1
(43) Pub. Date: Feb. 8, 2018

(54) BOOKLET

(71) Applicant: DE LA RUE INTERNATIONAL LIMITED, Basingstoke, Hampshire (GB)

(72) Inventor: Matthew Charles SUGDON, Basingstoke (GB)

(73) Assignee: DE LA RUE INTERNATIONAL LIMITED, Basingstoke, Hampshire (GB)

(21) Appl. No.: 15/553,951

(22) PCT Filed: Feb. 25, 2016
(86) PCT No.: PCT/GB2016/050483

§ 371 Date: Aug. 25, 2017

(30) Foreign Application Priority Data
Feb. 25, 2015 (GB) 1503135.4

(51) Int. Cl. B42C 19/00; B42D 25/333; B42D 25/309; B42D 25/355; B42D 25/373; B42D 25/24; B42D 25/328

(52) U.S. Cl. CPC B42C 19/00; B42D 25/24; B42D 25/333; B42D 25/328; B42D 25/355; B42D 25/373; B42D 25/309

(57) ABSTRACT

A booklet includes a book block having at least two sheets stitched together. When the sheets are folded along a line parallel with stitching so each sheet defines a leaf on each side of fold line, the sheets form an innermost and outermost sheet. The stitching's obverse side is exposed on the innermost sheet's inner surface and stitching's reverse side is exposed on the outermost sheet's outer surface. A cover member has inner and outer surfaces, the inner surface defining first and second cover pages one on each side of cover fold line. The block is attached to cover member by attaching a block's leaf to first cover page defining a first end page, the block's leaf defining the first end page being selected so the block can be opened in two different configurations to reveal respectively the stitching's obverse and reverse sides without detaching the block from cover member.

The invention relates to a booklet, for example a security booklet such as a pass book or an identity booklet, for example comprising a passport.

In the case of these booklets, it is important to be able to prevent or at least detect tampering and the production of fraudulent booklets. Many different methods are currently used to achieve this by, for example, including complex watermarks, incorporating special materials in the stitching or the pages, the inclusion of encoded biodata and the like. However, there is still a problem that skilled fraudsters can extract pages from a genuine booklet, replace them, and re-insert the pages into a cover of the booklet in such a way that is very difficult to detect.

A conventional method of constructing a passport is described in CA-A-2091109 in which a set of sheets are stitched together along a fold line. Further examples of known booklet constructions are described in WO 94/05509 and WO 2008/015708.

In accordance with the present invention, we provide a booklet comprising a book block having at least two sheets, secured together by stitching whereby when the sheets are folded along a fold line substantially parallel with the stitching such that each sheet defines a pair of leaves one on each side of the fold line, the sheets form an innermost sheet and an outermost sheet, wherein an obverse side of the stitching is exposed on the inner surface of the innermost sheet and a reverse side of the stitching is exposed on the outer surface of the outermost sheet; and a cover member having inner and outer surfaces, the inner surface defining first and second cover pages one on each side of a cover fold line, wherein the book block is attached to the cover member by attaching a leaf of the book block to the first cover page to define a first end page, the leaf of the book block defining the first end page being selected such that the book block can be opened in two different configurations to reveal respectively the obverse and reverse sides of the stitching without detaching the book block from the cover member.

The effect of this configuration is that when the sheets are folded along the fold line at least two leaves from the same sheet are located between the innermost sheet and a cover page on one side of the fold line while, between the innermost sheet and the other cover page on the other side of the fold line, is located a single leaf only from the or each other sheet.

One reason why some falsified documents such as counterfeit passports cannot be detected is because fraudsters are able very carefully to unstitch one or more sheets from the book block and replace the sheet or sheets and then reinstate the stitching in such a way that it is not obvious that this substitution has occurred. We have realised that one of the reasons for this is that persons wishing to authenticate a document have to make an extra, time-consuming check on the integrity of the stitch line during examination.

With the invention, the stitching can be viewed by the authenticator by suitably opening the book block to respective configurations such that both the obverse and reverse sides of the stitching may be examined for signs of tampering without detaching the sheets from the cover and this makes it very difficult for a fraudster to tamper with the stitching without detection.

A particular advantage of the invention is that the book block can be made conventionally and it is simply a matter of folding one or more of the sheets back around the fold line before attaching the book block to the cover member. For example, the book block may be attached to the cover member by attaching a leaf of a sheet other than the outermost sheet to the first cover page to define the first end page.

One or more additional sheets may be located between the innermost and outermost sheets to which they are joined by the stitching, each additional sheet being foldable about the fold line of the book block to define a respective pair of leaves.

Typically, the pages will be laid one on the other and stitched together along the fold line. However, in an alternative approach, the sheets could be folded into a generally L-shaped form and then assembled together in two groups of one or more sheets with the leaves defining one arm of each L arranged back-to-back with those of the other group. The sheets would then be stitched together.

In preferred examples, the book block is attached to the cover member by attaching another leaf of the book block to the second cover page to define a second end page being selected such that the book block can be opened in two different configurations to reveal the reverse and obverse sides of the stitching, without detaching the book block from the cover member. However, it is also envisaged that in certain embodiments, only one leaf of the book block is attached to the cover member while a second, separate sheet is used to define the other or second end page.

Typically, the fold line about which the sheets of the book block are folded is defined by the stitching. However, the stitching and fold line may not always be collinear and there could be an offset between them of for example up to 1 mm.

Conveniently, the leaves defining first and second end pages are attached to the cover page by adhesive. This adhesive may extend uniformly across the entirety of the respective leaves or could be applied in spots. The former method minimizes the chances of being able to detach the end pages from the cover member without the tamper being evident. Of course, other methods of attaching the leaves to the cover member could be used including stapling and the like.

In the case of a secure or security booklet, the pages of the booklet may be provided with one or more security features of a conventional form such as fine-line printing; intaglio printing; embossed metallic foils; optically variable elements, holograms, Kinegrams or angularly dependent colour shifting effects, watermarks and the like. In a particularly preferred example, the security features such as security printing, security threads or watermarks may be registered within individual pages or indeed between pages. Other security features, particularly for use in a security booklet forming an identity booklet such as a passport, typically include personal data relating to a holder of the booklet provided on one or more of the pages. This could be laminated onto the page or printed or otherwise provided directly on the page. Examples of personal data or biodata include a person's photo image, data regarding their date of birth, address and the like together with encoded data for use by an authenticating machine.

The international Civil Aviation Organisation standard provides that the biodata page is located on the inner surface of the first leaf, that is to say on page 2 of the booklet. In a typical 32 page document, an alternative arrangement would place the biodata page on page 31. Wherever, the biodata page is located within the booklet, it is particularly preferred that the book block is configured so that the personal data and one side of the stitching can be viewed at the same time. This makes it very easy for an immigration official or other authenticator to examine the integrity of the stitching at the same time as scrutinising the personal data. The authenticator then only needs to turn the leaves of the booklet to see the other side of the stitching.

In some examples, one end page is provided with a watermark, the watermark extending across the fold line of the sheet providing the one end page.

In further examples the biodata page is provided with security features, such as printing but can also be provided with watermarks, security threads etc. that extends over more than one page in a continuous pattern. This presents significant difficulties to a potential counterfeiter since any attempt to separate part of said personalized page sheet will be more easily detected due to breaks in the continuous security pattern.

Of course, a watermark or other security features could be applied to any of the sheets and extending through the stitching region to increase the difficulty of replacing a single page.

Although the invention is applicable to book blocks comprising just two sheets, it is also applicable to a book block having more than two sheets.

In most cases, all of the sheets of the book block will have similar dimensions so as to define equally sized leaves on either side of the stitching. However, in some cases, at least one sheet may be sized to define a single leaf with a tab region protruding beyond the stitching.

The page sheets may be made of any conventional material such as paper, card, or plastics, such as polycarbonate, while the cover also may be made of conventional materials such as paper, card, plastics such as PVC, polyethylene, polycarbonate, PET, coated paper, woven fabric and non-woven synthetic material.

A primary example of the use of such a booklet is as a passport but other applications include bank books, savings books, writing books and the like.

An example of a passport according to the present invention will now be described and contrasted with a conventional structure with reference to the accompanying drawings, in which:—

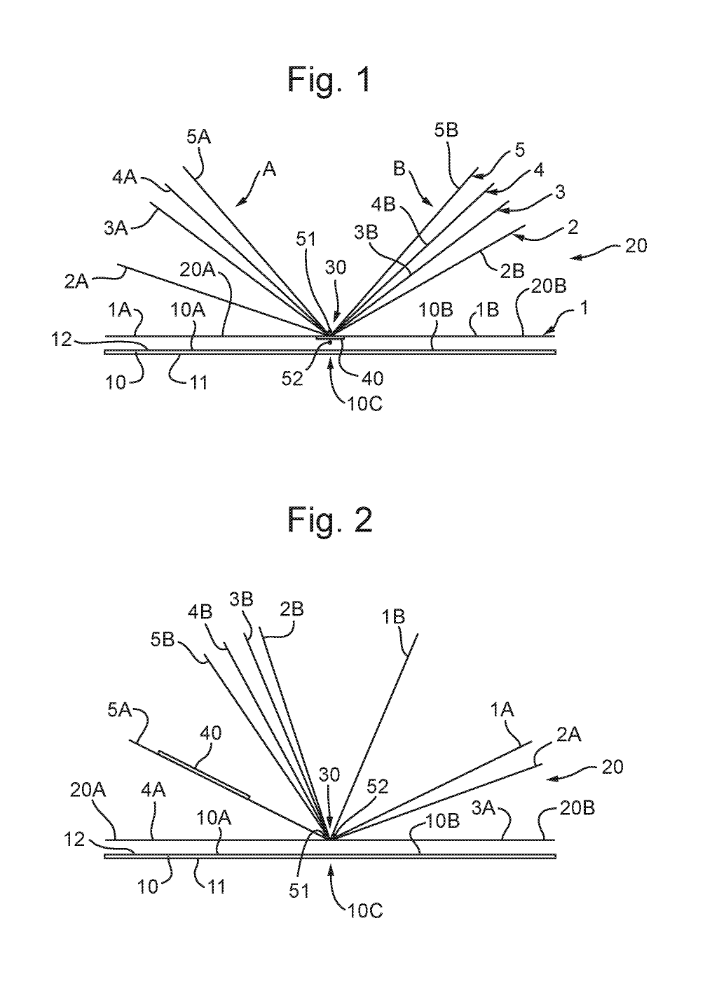

FIG. 1 is a schematic side view of a conventional passport;

FIG. 2 is a view similar to FIG. 1 but of an example of a passport according to the invention;

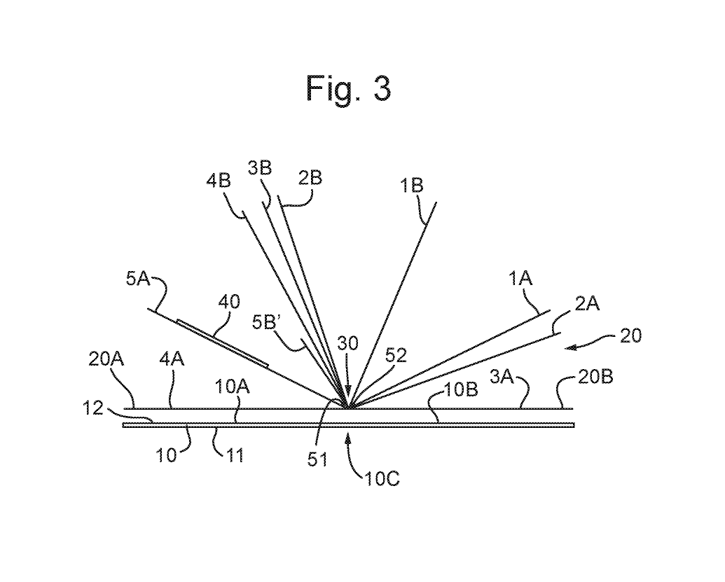

FIG. 3 is a view similar to FIG. 2 but showing a modified example of a passport going to the invention; and,

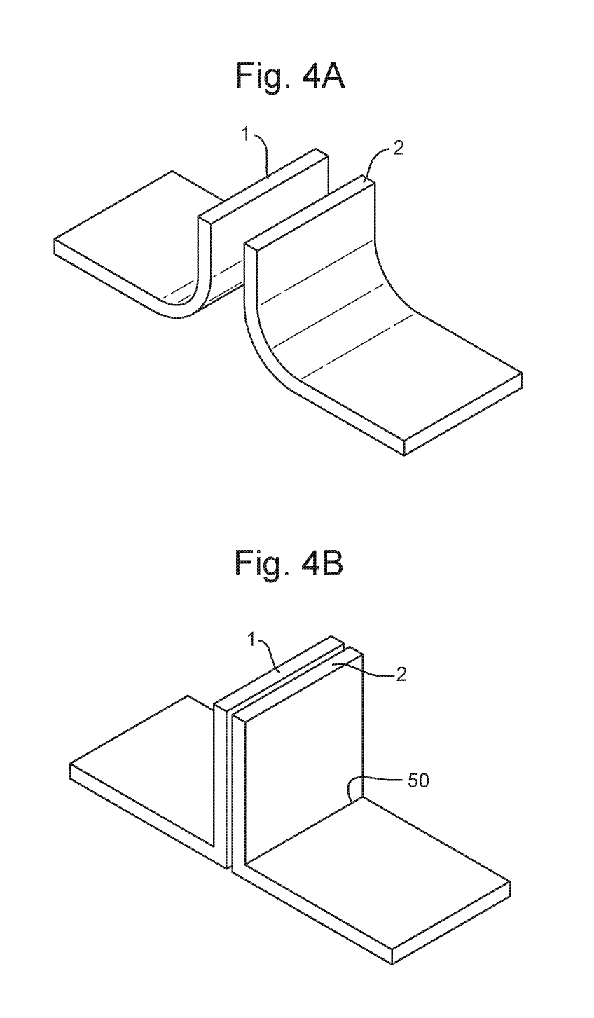

FIGS. 4a and 4b illustrate an alternative method of manufacturing the passport shown in FIGS. 2 and 3.

The conventional passport shown in FIG. 1 comprises a cover member 10 having an outer surface 11 and an inner surface 12. The cover member 10 is made of one or more of paper, fabric, non-woven textile materials, Teslin and composites constructions of the aforementioned materials and defines first and second cover pages 10A, 10B, on either side of a cover fold line 100, to which is attached a book block 20 formed by five sheets of paper comprising innermost sheet 5, outermost sheet 1, and additional sheets 2-4. The sheets are foldable about a fold line 30 so that there are an equal number of leaves (five) on each side A,B of the fold line 30. The innermost sheet 5 constitutes a centrefold.

In FIG. 1, the individual leaves on the left hand side of the fold line 30 are labelled 1A-5A while those on the right hand side of the fold line 30 are labelled 1B-5B. Each side of each leaf defines a respective page.

The sheets are joined together by stitching 50 extending along the fold line. An obverse side 51 of the stitching is visible or exposed on the inner surface of the innermost sheet 5 while a reverse side 52 of the stitching is exposed on the outer surface of the outermost sheet 1. A spine tape 40 is adhered to the outermost sheet 1 in the region of the fold line 30 to strengthen the fold line and covering the reverse side 52 of the stitching 50.

The book block 20 is secured to the cover member 10 by adhering the outermost sheet 1 to the cover member so that the leaves 1A and 1B are attached to cover pages 10A, 10B respectively so as to define respective first and second end pages 20A, 20B. The fold lines 10C, 30 are aligned.

Finally, personal or biodata is preferably provided on the inner surface of the leaf 2A either by lamination or direct printing. In addition, conventional watermarks and other security features can be provided on one or more of the leaves.

As explained above, one problem with this structure is that reverse side 52 of the stitching 50 between the spine tape 40 and the cover member 10 is not accessible to the authenticator who cannot therefore tell if that part of the stitching has been tampered with.

To overcome this problem, the invention changes the sheets which are adhered to the cover member so that both obverse and reverse sides 51, 52 of the stitching 50 can be seen. FIG. 2 illustrates one example that achieves this.

In FIG. 2, the same components shown in FIG. 1 have been given the same reference numerals for ease of comparison. In this structure, however, instead of the sheet 1 providing the first and second end pages 20A, 20B, these end pages are provided by leaves 4A and 3A respectively, adhered to corresponding cover pages 10A, 10B. As a result, the obverse and reverse sides 51, 52 of the stitching between leaves 5A and 5B and 1A and 1B respectively can be seen by suitably opening the booklet thus making it much easier for an authenticator to detect tampering of the stitching 50 without detaching the book block 20 from the cover 10.

Furthermore, it will be noted that these leaves of the sheets are asymmetrically arranged relative to the centrefold 5 and the cover 10. Thus, on one side of the centrefold 5 are provided both leaves of sheets 1, 2 and 3 while on the other side of the centrefold 5 is provided a single leaf A4 of the sheet 4. It is this asymmetric arrangement which means that by suitably opening the booklet the obverse and reverse sides 51, 52 of the stitching between the leaves 5A, 5B and 1A, 1B can be easily seen.

Conveniently, the biodata page shown as a lamination 40, is provided on the inner surface of the leaf 5A although of course it could be provided on any of the other pages. In another construction, the biodata page could be provided on leaf 3B taking advantage of the fact that the other part of the sheet 3, leaf 3A, defines the end page 20B which is adhered to the cover member 10.

In use, the authenticator or immigration officer will open up the passport to view the leaf 5A holding the personal data and this also allows him to see the obverse side 51 of the stitching 50 provided between the leaves 5A, 5B of the centrefold 5. He can then open up the book block 20 to reveal the space between leaves 1A, 1B and thus see the reverse side 52 of the stitching 50 for verification purposes. In this way, the authenticator can determine much more clearly whether or not the stitching 50 has been tampered with.

Although in this example, the stitching 50 has been shown as substantially coincident with the fold line 30, this is not essential and the two could be laterally offset by a small amount, for example by up to 1 mm.

In another modification, the leaf 4A could be adhered to the cover member 10 while the leaf 3A is not adhered to the cover member but remains free to be turned. In this case, the second end page 20B is provided by an additional sheet adhered to the cover member 10.

Further advantage can be taken of the fact that the passport can be opened in two different configurations allowing two continuous sheets to be viewed, namely sheets 1 and 5. This enables one or both of these sheets 1, 5 to be provided with a watermark (not shown) which extends through the fold line 30 and stitching 50 which can be easily authenticated. This provides an additional security feature. Of course alternative security features could extend through the fold line 30 such as security threads, surface applied foils or stripes, bands of security fibres embedded into the paper or printed security feature.

A further benefit of this structure is that a spine reinforcing tape is not required.

It will also be noted that the first and second end pages 4A, 3A are formed from different sheets of paper 4, 3 respectively and are bonded to the cover member 10 making it difficult to disassemble the booklet.

In the example, each sheet 1-5 has substantially the same size and is folded to define equally sized leaves. It would be possible, however, for one or more of the sheets to be sized so as to define one leaf and a small tab region extending through the region of the stitching.

In FIG. 2 for example all sheets 1-5 have the same size. However, it would also be possible for one or more of the sheets to have a different size from the other and an example is shown in FIG. 3. In this example, the sheet or centrefold 5 is shorter than the sheets 1-4 and is folded to define a leaf 5A carrying a lamination 40 forming the biodata page as before and a short, tab 5B′. In this case, one or both of the leaf 5A and tab 5B′ could be provided in a polymeric material, the leaf on which the biodata page is provided typically being of polycarbonate or polyester, particularly PET or PETG. The tab 5B is typically a thermoplastic material such as polyurethane, which may or may not be provided with textile or non-woven reinforcement. Thus, the tab 5B′ is made of a different material from the leaf 5A.

Typically, the book block 20 is manufactured by laying the sheets 1-5 one on top of the other in a flat configuration and then stitching them together.

In an alternative approach, the sheets could be arranged into groups of one or more sheets respectively and then abutted together as shown in FIG. 4. For simplicity, just two sheets 1, 2 are illustrated in FIG. 4. Thus, FIG. 4A illustrates how the two sheets 1, 2 are formed into a generally L-shaped configuration and then pushed together to enable them to be stitched as shown at 50 (FIG. 4B).

In any of the examples the cover may include an electronic chip and antenna secured thereto. For example, the cover might include an inlay, such as Teslin, incorporating the electronic chip and antenna.

1. A booklet comprising a book block having at least two sheets, secured together by stitching whereby when the sheets are folded along a fold line substantially parallel with the stitching such that each sheet defines a pair of leaves one on each side of the fold line, the sheets form an innermost sheet and an outermost sheet, wherein an obverse side of the stitching is exposed on the inner surface of the innermost sheet and a reverse side of the stitching is exposed on the outer surface of the outermost sheet; and a cover member having inner and outer surfaces, the inner surface defining first and second cover pages one on each side of a cover fold line, wherein the book block is attached to the cover member by attaching a leaf of the book block to the first cover page to define a first end page, the leaf of the book block defining the first end page being selected such that the book block can be opened in two different configurations to reveal respectively the obverse and reverse sides of the stitching without detaching the book block from the cover member.

2. A booklet according to claim 1, wherein the book block is attached to the cover member by attaching a leaf of a sheet other than the outermost sheet to the first cover page to define the first end page.

3. A booklet according to claim 1, wherein one or more additional sheets are located between the innermost and outermost sheets to which they are joined by the stitching, each additional sheet being foldable about the fold line of the book block to define a respective pair of leaves.

4. A booklet according to claim 1, wherein the book block is attached to the cover member by attaching another leaf of the book block to the second cover page to define a second end page, the leaves of the book block defining the first and second end pages being selected such that the book block can be opened in two different configurations to reveal the obverse and reverse sides of the stitching, without detaching the book block from the cover member.

5. A booklet according to claim 1, wherein the fold line about which the sheets of the book block are folded is defined by the stitching.

6. A booklet according to claim 1, wherein the leaf defining the first end page, and the leaf defining the second end page, if provided, is attached to the cover page by adhesive.

7. A booklet according to claim 1 wherein personal data relating to a holder of the booklet is provided on one of the pages.

8. A booklet according to claim 7, wherein the book block is configured so that the personal data and one side of the stitching can be viewed at the same time.

9. A booklet according to claim 1, wherein one end page is provided with a watermark, the watermark extending across the fold line of the sheet providing the one end page.

10. A booklet according to claim 1, wherein all the sheets of the book block have similar dimensions so as to define equally sized leaves.

11. A booklet according to claim 1, wherein at least one sheet is sized to define a single leaf with a tab region protruding beyond the stitching.

12. A secure booklet comprising a booklet according to claim 1, one or more of the sheets of the booklet being provided with a security feature.

13. A secure booklet according to claim 12, wherein the security feature is one of fine-line printing; intaglio printing; an embossed metallic foil; an optically variable element, a hologram, Kinegram or other device having angularly dependent colour shifting effects, a watermark, security printing, a security thread and personal data relating to a holder of the booklet.
